(19) United States
(12) Patent Application Publication
(10) Pub. No.: US 2026/0143458 A1
(43) Pub. Date: May 21, 2026

(54) ELECTRONIC DEVICE FOR POSITIONING AND OPERATING METHOD THEREOF

(71) Applicant: Samsung Electronics Co., Ltd., Suwon-si (KR)

(72) Inventors: Sejong YOON, Suwon-si (KR); Moonseok KANG, Suwon-si (KR); Kwanghoon HAN, Suwon-si (KR)

(21) Appl. No.: 19/449,010

(22) Filed: Jan. 14, 2026

Related U.S. Application Data
(63) Continuation of application No. PCT/KR2024/008078, filed on Jun. 12, 2024.

(30) Foreign Application Priority Data
Jul. 14, 2023 (KR) 10-2023-0092090
Jul. 20, 2023 (KR) 10-2023-0094945
Jul. 25, 2023 (KR) 10-2023-0097083

(51) Int. Cl. H04W 64/00; H04B 1/7163; H04B 17/318

(52) U.S. Cl. CPC H04W 64/00; H04B 1/7163; H04B 17/318

(57) ABSTRACT

A method of operating an electronic device may include: obtaining measurement location information including a plurality of measurement locations and distance information including a plurality of distances between the plurality of measurement locations and a target electronic device; obtaining first location information of the target electronic device based on the measurement location information and the distance information; identifying the accuracy of the first location information based on the measurement location information, the distance information, and the first location information; and determining the location of the target electronic device based on the accuracy of the first location information.

### CROSS-REFERENCE TO RELATED APPLICATIONS

This application is a continuation of International Application No. PCT/KR2024/008078 designating the United States, filed on Jun. 12, 2024, in the Korean Intellectual Property Receiving Office and claiming priority to Korean Patent Application Nos. 10-2023-0092090, filed on Jul. 14, 2023, 10-2023-0094945, filed on Jul. 20, 2023, and 10-2023-0097083, filed on Jul. 25, 2023, in the Korean Intellectual Property Office, the disclosures of each of which are incorporated by reference herein in their entireties.

### BACKGROUND

### Field

The disclosure relates to an electronic device for positioning and an operating method thereof.

### Description of Related Art

With the development of technologies, various electronic devices, such as portable communication devices (for example, smartphones), computer devices, portable multimedia devices, or portable medical devices, have appeared, and new technologies are applied to conventional electronic devices such as cameras, wearable devices, or home appliances. Therefore, electronic devices use new technologies to be able to provide new forms of services.

Positioning technology is one of technologies enabling such new forms of services, and varies depending on its object and an electronic device performing positioning. Electronic devices may determine locations of persons or objects using positioning technology, and may provide location-based services (LBS) which are useful in various fields such as daily life, disasters, safety, or logistics using space information or geographic information.

Positioning technology with high accuracy is needed to provide various and useful services. Positioning technology for outdoor environments may guarantee accuracy and stability and may provide high-level performance using global navigation satellite system (GNSS) such as global positioning system (GPS), globalnaya navigatsionnaya sputnikovaya sistema (GLONASS), Galileo. However, positioning may be difficult to perform in indoor spaces or underground spaces where it is impossible to receive satellite signals. To provide various services in indoor environments, positioning technology with high accuracy may be needed.

### SUMMARY

Embodiments of the disclosure provide an electronic device for positioning and an operating method thereof.

A method of operating an electronic device according to an example embodiment of the disclosure may include: acquiring measurement location information including a plurality of measurement locations, and distance information including a plurality of distances between the plurality of measurement locations and a target electronic device; acquiring first location information of the target electronic device based on the measurement location information and the distance information; identifying an accuracy of the first location information based on the measurement location information, the distance information, and the first location information; and determining a location of the target electronic device based on the accuracy of the first location information.

An electronic device according to an example embodiment of the disclosure may include: a communication circuit, a memory configured to store instructions, and at least one processor, comprising processing circuitry, connected with the communication circuit and the memory, wherein at least one processor, individually and/or collectively, is configured to execute the instructions, and to cause the electronic device to: acquire measurement location information including a plurality of measurement locations, and distance information including a plurality of distances between the plurality of measurement locations and a target electronic device, acquire first location information of the target electronic device based on the measurement location information and the distance information, identify an accuracy of the first location information based on the measurement location information, the distance information, and the first location information, and determine a location of the target electronic device based on the accuracy of the first location information.

According to an example embodiment of the disclosure, there are provided an electronic device for positioning which is capable of providing high accuracy, and an operating method thereof.

The effects achieved by the disclosure are not limited to those mentioned above, and other effects that are not mentioned above may be clearly understood to those skilled in the art to which the disclosure belongs, based on the description provided below.

### BRIEF DESCRIPTION OF THE DRAWINGS

The above and other aspects, features and advantages of certain embodiments of the present disclosure will be more apparent from the following detailed description, taken in conjunction with the accompanying drawings, in which:

FIG. 1 is a block diagram of an example electronic device in a network environment according to various embodiments;

FIG. 2 is a block diagram illustrating an example configuration of an electronic device according to various embodiments;

FIG. 3 is a diagram illustrating an example operation of measuring a distance between an electronic device and a target electronic device according to various embodiments;

FIG. 4 is a diagram illustrating an example operation of determining a location of a target electronic device according to various embodiments;

FIG. 5 is a flowchart illustrating an example method of operating an electronic device according to various embodiments;

FIG. 6 is a diagram illustrating an example dilution of precision (DoP) according to various embodiments;

FIGS. 7A and 7B are a flowchart and diagram illustrating an example operation of determining a location of a target electronic device based on accuracy of first location information according to various embodiments;

FIG. 8 is a diagram illustrating an example operation of outputting measurement location information according to various embodiments;

FIG. 9 is a diagram illustrating an example operation of outputting a location of a target electronic device according to various embodiments;

FIG. 10 is a diagram illustrating an example operation for acquiring location information and distance information of an electronic device according to various embodiments; and

FIG. 11 is a flowchart illustrating an example method operating of an electronic device according to various embodiments.

### DETAILED DESCRIPTION

According to an example embodiment of the disclosure, a method of operating an electronic device may include: acquiring measurement location information including a plurality of measurement locations, and distance information including a plurality of distances between the plurality of measurement locations and a target electronic device; acquiring first location information of the target electronic device based on the measurement location information and the distance information; identifying an accuracy of the first location information based on the measurement location information, the distance information, and the first location information; and determining a location of the target electronic device based on the accuracy of the first location information.

In an example embodiment, determining the location of the target electronic device may include: based on the accuracy being less than a threshold value, acquiring additional measurement location information including at least one additional measurement location, and additional distance information including at least one distance between the at least one additional measurement location and the target electronic device; acquiring second location information of the target electronic device based on the additional measurement location information and the additional distance information; identifying an accuracy of the second location information based on the additional measurement location information, the additional distance information, and the second location information; and determining the location of the target electronic device based on the second location information.

In an example embodiment, the method may further include: acquiring preference measurement location information related to a measurement location where it is possible to improve the accuracy; and outputting the preference measurement location information.

In an example embodiment, determining the location of the target electronic device based on the accuracy of the first location information may include, based on the accuracy being greater than or equal to a threshold value, determining the location of the target electronic device based on the first location information.

In an example embodiment, identifying the accuracy of the first location information may include: acquiring a dilution of precision (DoP) value based on the distance information and the first location information; and identifying the accuracy of the first location information based on the DoP value.

In an example embodiment, identifying the accuracy of the first location information may include identifying the accuracy of the first location information based on at least one of a distance between the electronic device and the target electronic device, whether the electronic device and the target electronic device are in a line of sight (LOS) environment, and a strength of a measured signal.

In an example embodiment, acquiring the measurement location information and the distance information may include acquiring a location of the electronic device and a distance between the electronic device and the target electronic device at each of the plurality of measurement locations.

In an example embodiment, acquiring the measurement location information and the distance information may include: acquiring a first location of the electronic device and a first distance between the electronic device and the target electronic device at a first measurement location; acquiring a second location of the electronic device and a second distance between the electronic device and the target electronic device at a second measurement location different from the first measurement location; and acquiring a third location of the electronic device and a third distance between the electronic device and the target electronic device at a third measurement location different from the first measurement location and the second measurement location, the measurement location information may include the first location, the second location, and the third location, and the distance information may include the first distance, the second distance, and the third distance.

In an example embodiment, the plurality of measurement locations may be at least a part of locations for acquiring location information of the electronic device.

In an example embodiment, acquiring the distance information may include acquiring the distance information using an ultra-wideband (UWB) module.

According to an example embodiment of the disclosure, an electronic device may include: a communication circuit, a memory configured to store instructions, and at least one processor, comprising processing circuitry, connected with the communication circuit and the memory and configured to execute the instructions wherein at least one processor, individually and/or collectively, is configured to cause the electronic device to: acquire measurement location information including a plurality of measurement locations, and distance information including a plurality of distances between the plurality of measurement locations and a target electronic device, acquire first location information of the target electronic device based on the measurement location information and the distance information, identify an accuracy of the first location information based on the measurement location information, the distance information, and the first location information, and determine a location of the target electronic device based on the accuracy of the first location information.

In an example embodiment, by executing the instructions, at least one processor may, when the accuracy is less than or equal to a threshold value, acquire additional measurement location information which includes at least one additional measurement location, and additional distance information which includes at least one distance between the at least one additional measurement location and the target electronic device, may acquire second location information of the target electronic device based on the additional measurement location information and the additional distance information, may identify an accuracy of the second location information based on the additional measurement location information, the additional distance information, and the second location information, and may determine the location of the target electronic device based on the second location information.

In an example embodiment, by executing the instructions, the at least one processor may acquire preference measurement location information related to a measurement location where it is possible to improve the accuracy, and may output the preference measurement location information.

In an example embodiment, by executing the instructions, the at least one processor may, based on the accuracy being greater than or equal to a threshold value, determine the location of the target electronic device based on the first location information.

In an example embodiment, by executing the instructions, the at least one processor may acquire a dilution of precision (DoP) value based on the distance information and the first location information, and may identify the accuracy of the first location information based on the DoP value.

In an example embodiment, by executing the instructions, the at least one processor may identify the accuracy of the first location information based on at least one of a distance between the electronic device and the target electronic device, whether the electronic device and the target electronic device are in a line of sight (LOS) environment, and a strength of a measured signal.

In an example embodiment, by executing the instructions, the at least one processor may acquire a location of the electronic device and a distance between the electronic device and the target electronic device at each of the plurality of measurement locations.

In an example embodiment, by executing the instructions, the at least one processor may acquire a first location of the electronic device and a first distance between the electronic device and the target electronic device at a first measurement location, may acquire a second location of the electronic device and a second distance between the electronic device and the target electronic device at a second measurement location different from the first measurement location, and may acquire a third location of the electronic device and a third distance between the electronic device and the target electronic device at a third measurement location different from the first measurement location and the second measurement location, the measurement location information may include the first location, the second location, and the third location, and the distance information may include the first distance, the second distance, and the third distance.

In an example embodiment, the plurality of measurement locations may be at least a part of locations for acquiring location information of the electronic device.

In an example embodiment, the communication circuit may include an ultra-wideband (UWB) module, and, by executing the instructions, the at least one processor may acquire the distance information using the UWB module.

Hereinafter, various example embodiments of the disclosure will be described in greater detail with reference to the accompanying drawings.

In explaining the various embodiments, the technical contents that are well known in the technical field to which the disclosure belongs and is not directly related to the disclosure may not be described. This is to avoid obscuring the essence of the disclosure and to convey it more clearly by omitting redundant explanations.

Some components in the drawings attached herewith are exaggerated, omitted, or are schematically illustrated. Furthermore, the size of each component does not necessarily reflect its actual size. The same reference numerals are assigned to the same or corresponding components in each drawing.

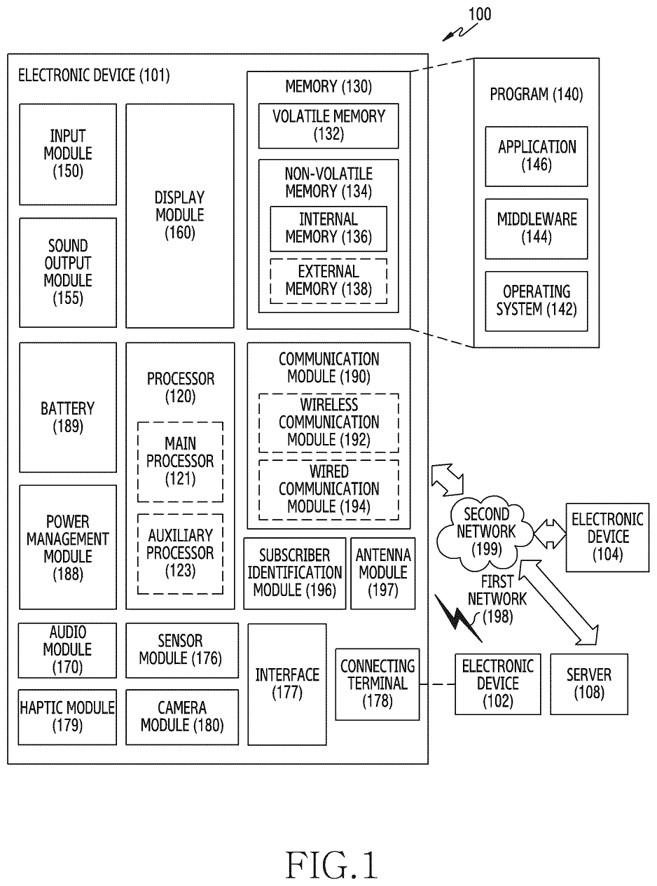

FIG. 1 is a block diagram of an example electronic device in a network environment according to various embodiments.

FIG. 1 is a block diagram illustrating an electronic device 101 in a network environment 100 according to various embodiments. Referring to FIG. 1, the electronic device 101 in the network environment 100 may communicate with an electronic device 102 via a first network 198 (e.g., a short-range wireless communication network), or at least one of an electronic device 104 or a server 108 via a second network 199 (e.g., a long-range wireless communication network). According to an embodiment, the electronic device 101 may communicate with the electronic device 104 via the server 108. According to an embodiment, the electronic device 101 may include a processor 120, memory 130, an input module 150, a sound output module 155, a display module 160, an audio module 170, a sensor module 176, an interface 177, a connecting terminal 178, a haptic module 179, a camera module 180, a power management module 188, a battery 189, a communication module 190, a subscriber identification module (SIM) 196, or an antenna module 197. In various embodiments, at least one of the components (e.g., the connecting terminal 178) may be omitted from the electronic device 101, or one or more other components may be added in the electronic device 101. In various embodiments, some of the components (e.g., the sensor module 176, the camera module 180, or the antenna module 197) may be implemented as a single component (e.g., the display module 160).

The processor 120 may execute, for example, software (e.g., a program 140) to control at least one other component (e.g., a hardware or software component) of the electronic device 101 coupled with the processor 120, and may perform various data processing or computation. According to an embodiment, as at least part of the data processing or computation, the processor 120 may store a command or data received from another component (e.g., the sensor module 176 or the communication module 190) in volatile memory 132, process the command or the data stored in the volatile memory 132, and store resulting data in non-volatile memory 134. According to an embodiment, the processor 120 may include a main processor 121 (e.g., a central processing unit (CPU) or an application processor (AP)), or an auxiliary processor 123 (e.g., a graphics processing unit (GPU), a neural processing unit (NPU), an image signal processor (ISP), a sensor hub processor, or a communication processor (CP)) that is operable independently from, or in conjunction with, the main processor 121. For example, when the electronic device 101 includes the main processor 121 and the auxiliary processor 123, the auxiliary processor 123 may be adapted to consume less power than the main processor 121, or to be specific to a specified function. The auxiliary processor 123 may be implemented as separate from, or as part of the main processor 121. Thus, the processor 120 may include various processing circuitry and/or multiple processors. For example, as used herein, including the claims, the term “processor” may include various processing circuitry, including at least one processor, wherein one or more of at least one processor, individually and/or collectively in a distributed manner, may be configured to perform various functions described herein. As used herein, when “a processor”, “at least one processor”, and “one or more processors” are described as being configured to perform numerous functions, these terms cover situations, for example and without limitation, in which one processor performs some of recited functions and another processor(s) performs other of recited functions, and also situations in which a single processor may perform all recited functions. Additionally, the at least one processor may include a combination of processors performing various of the recited/disclosed functions, e.g., in a distributed manner. At least one processor may execute program instructions to achieve or perform various functions.

The auxiliary processor 123 may control at least some of functions or states related to at least one component (e.g., the display module 160, the sensor module 176, or the communication module 190) among the components of the electronic device 101, instead of the main processor 121 while the main processor 121 is in an inactive (e.g., sleep) state, or together with the main processor 121 while the main processor 121 is in an active state (e.g., executing an application). According to an embodiment, the auxiliary processor 123 (e.g., an image signal processor or a communication processor) may be implemented as part of another component (e.g., the camera module 180 or the communication module 190) functionally related to the auxiliary processor 123. According to an embodiment, the auxiliary processor 123 (e.g., the neural processing unit) may include a hardware structure specified for artificial intelligence model processing. An artificial intelligence model may be generated by machine learning. Such learning may be performed, e.g., by the electronic device 101 where the artificial intelligence is performed or via a separate server (e.g., the server 108). Learning algorithms may include, but are not limited to, e.g., supervised learning, unsupervised learning, semi-supervised learning, or reinforcement learning. The artificial intelligence model may include a plurality of artificial neural network layers. The artificial neural network may be a deep neural network (DNN), a convolutional neural network (CNN), a recurrent neural network (RNN), a restricted boltzmann machine (RBM), a deep belief network (DBN), a bidirectional recurrent deep neural network (BRDNN), deep Q-network or a combination of two or more thereof but is not limited thereto. The artificial intelligence model may, additionally or alternatively, include a software structure other than the hardware structure.

The memory 130 may store various data used by at least one component (e.g., the processor 120 or the sensor module 176) of the electronic device 101. The various data may include, for example, software (e.g., the program 140) and input data or output data for a command related thereto. The memory 130 may include the volatile memory 132 or the non-volatile memory 134.

The program 140 may be stored in the memory 130 as software, and may include, for example, an operating system (OS) 142, middleware 144, or an application 146.

The input module 150 may receive a command or data to be used by another component (e.g., the processor 120) of the electronic device 101, from the outside (e.g., a user) of the electronic device 101. The input module 150 may include, for example, a microphone, a mouse, a keyboard, a key (e.g., a button), or a digital pen (e.g., a stylus pen).

The sound output module 155 may output sound signals to the outside of the electronic device 101. The sound output module 155 may include, for example, a speaker or a receiver. The speaker may be used for general purposes, such as playing multimedia or playing record. The receiver may be used for receiving incoming calls. According to an embodiment, the receiver may be implemented as separate from, or as part of the speaker.

The display module 160 may visually provide information to the outside (e.g., a user) of the electronic device 101. The display module 160 may include, for example, a display, a hologram device, or a projector and control circuitry to control a corresponding one of the display, hologram device, and projector. According to an embodiment, the display module 160 may include a touch sensor adapted to detect a touch, or a pressure sensor adapted to measure the intensity of force incurred by the touch.

The audio module 170 may convert a sound into an electrical signal and vice versa. According to an embodiment, the audio module 170 may obtain the sound via the input module 150, or output the sound via the sound output module 155 or a headphone of an external electronic device (e.g., an electronic device 102) directly (e.g., wiredly) or wirelessly coupled with the electronic device 101.

The sensor module 176 may detect an operational state (e.g., power or temperature) of the electronic device 101 or an environmental state (e.g., a state of a user) external to the electronic device 101, and then generate an electrical signal or data value corresponding to the detected state. According to an embodiment, the sensor module 176 may include, for example, a gesture sensor, a gyro sensor, an atmospheric pressure sensor, a magnetic sensor, an acceleration sensor, a grip sensor, a proximity sensor, a color sensor, an infrared (IR) sensor, a biometric sensor, a temperature sensor, a humidity sensor, or an illuminance sensor.

The interface 177 may support one or more specified protocols to be used for the electronic device 101 to be coupled with the external electronic device (e.g., the electronic device 102) directly (e.g., wiredly) or wirelessly. According to an embodiment, the interface 177 may include, for example, a high definition multimedia interface (HDMI), a universal serial bus (USB) interface, a secure digital (SD) card interface, or an audio interface.

A connecting terminal 178 may include a connector via which the electronic device 101 may be physically connected with the external electronic device (e.g., the electronic device 102). According to an embodiment, the connecting terminal 178 may include, for example, a HDMI connector, a USB connector, a SD card connector, or an audio connector (e.g., a headphone connector).

The haptic module 179 may convert an electrical signal into a mechanical stimulus (e.g., a vibration or a movement) or electrical stimulus which may be recognized by a user via his tactile sensation or kinesthetic sensation. According to an embodiment, the haptic module 179 may include, for example, a motor, a piezoelectric element, or an electric stimulator.

The camera module 180 may capture a still image or moving images. According to an embodiment, the camera module 180 may include one or more lenses, image sensors, image signal processors, or flashes.

The power management module 188 may manage power supplied to the electronic device 101. According to an embodiment, the power management module 188 may be implemented as at least part of, for example, a power management integrated circuit (PMIC).

The battery 189 may supply power to at least one component of the electronic device 101. According to an embodiment, the battery 189 may include, for example, a primary cell which is not rechargeable, a secondary cell which is rechargeable, or a fuel cell.

The communication module 190 may support establishing a direct (e.g., wired) communication channel or a wireless communication channel between the electronic device 101 and the external electronic device (e.g., the electronic device 102, the electronic device 104, or the server 108) and performing communication via the established communication channel. The communication module 190 may include one or more communication processors that are operable independently from the processor 120 (e.g., the application processor (AP)) and supports a direct (e.g., wired) communication or a wireless communication. According to an embodiment, the communication module 190 may include a wireless communication module 192 (e.g., a cellular communication module, a short-range wireless communication module, or a global navigation satellite system (GNSS) communication module) or a wired communication module 194 (e.g., a local area network (LAN) communication module or a power line communication (PLC) module). A corresponding one of these communication modules may communicate with the external electronic device via the first network 198 (e.g., a short-range communication network, such as Bluetooth™, wireless-fidelity (Wi-Fi) direct, or infrared data association (IrDA)) or the second network 199 (e.g., a long-range communication network, such as a legacy cellular network, a 5G network, a next-generation communication network, the Internet, or a computer network (e.g., LAN or wide area network (WAN)). These various types of communication modules may be implemented as a single component (e.g., a single chip), or may be implemented as multi components (e.g., multi chips) separate from each other. The wireless communication module 192 may identify and authenticate the electronic device 101 in a communication network, such as the first network 198 or the second network 199, using subscriber information (e.g., international mobile subscriber identity (IMSI)) stored in the subscriber identification module 196.

The wireless communication module 192 may support a 5G network, after a 4G network, and next-generation communication technology, e.g., new radio (NR) access technology. The NR access technology may support enhanced mobile broadband (eMBB), massive machine type communications (mMTC), or ultra-reliable and low-latency communications (URLLC). The wireless communication module 192 may support a high-frequency band (e.g., the mmWave band) to achieve, e.g., a high data transmission rate. The wireless communication module 192 may support various technologies for securing performance on a high-frequency band, such as, e.g., beamforming, massive multiple-input and multiple-output (massive MIMO), full dimensional MIMO (FD-MIMO), array antenna, analog beam-forming, or large scale antenna. The wireless communication module 192 may support various requirements specified in the electronic device 101, an external electronic device (e.g., the electronic device 104), or a network system (e.g., the second network 199). According to an embodiment, the wireless communication module 192 may support a peak data rate (e.g., 20 Gbps or more) for implementing eMBB, loss coverage (e.g., 164 dB or less) for implementing mMTC, or U-plane latency (e.g., 0.5 ms or less for each of downlink (DL) and uplink (UL), or a round trip of Ims or less) for implementing URLLC.

The antenna module 197 may transmit or receive a signal or power to or from the outside (e.g., the external electronic device) of the electronic device 101. According to an embodiment, the antenna module 197 may include an antenna including a radiating element including a conductive material or a conductive pattern formed in or on a substrate (e.g., a printed circuit board (PCB)). According to an embodiment, the antenna module 197 may include a plurality of antennas (e.g., array antennas). In such a case, at least one antenna appropriate for a communication scheme used in the communication network, such as the first network 198 or the second network 199, may be selected, for example, by the communication module 190 (e.g., the wireless communication module 192) from the plurality of antennas. The signal or the power may then be transmitted or received between the communication module 190 and the external electronic device via the selected at least one antenna. According to an embodiment, another component (e.g., a radio frequency integrated circuit (RFIC)) other than the radiating element may be additionally formed as part of the antenna module 197.

According to an embodiments, the antenna module 197 may form a mm Wave antenna module. According to an embodiment, the mmWave antenna module may include a printed circuit board, a RFIC disposed on a first surface (e.g., the bottom surface) of the printed circuit board, or adjacent to the first surface and capable of supporting a designated high-frequency band (e.g., the mm Wave band), and a plurality of antennas (e.g., array antennas) disposed on a second surface (e.g., the top or a side surface) of the printed circuit board, or adjacent to the second surface and capable of transmitting or receiving signals of the designated high-frequency band.

At least some of the above-described components may be coupled mutually and communicate signals (e.g., commands or data) therebetween via an inter-peripheral communication scheme (e.g., a bus, general purpose input and output (GPIO), serial peripheral interface (SPI), or mobile industry processor interface (MIPI)).

According to an embodiment, commands or data may be transmitted or received between the electronic device 101 and the external electronic device 104 via the server 108 coupled with the second network 199. Each of the electronic devices 102 or 104 may be a device of a same type as, or a different type, from the electronic device 101. According to an embodiment, all or some of operations to be executed at the electronic device 101 may be executed at one or more of the external electronic devices 102, 104, or 108. For example, if the electronic device 101 should perform a function or a service automatically, or in response to a request from a user or another device, the electronic device 101, instead of, or in addition to, executing the function or the service, may request the one or more external electronic devices to perform at least part of the function or the service. The one or more external electronic devices receiving the request may perform the at least part of the function or the service requested, or an additional function or an additional service related to the request, and transfer an outcome of the performing to the electronic device 101. The electronic device 101 may provide the outcome, with or without further processing of the outcome, as at least part of a reply to the request. To that end, a cloud computing, distributed computing, mobile edge computing (MEC), or client-server computing technology may be used, for example. The electronic device 101 may provide ultra low-latency services using, e.g., distributed computing or mobile edge computing. In an embodiment, the external electronic device 104 may include an internet-of-things (IoT) device. The server 108 may be an intelligent server using machine learning and/or a neural network. According to an embodiment, the external electronic device 104 or the server 108 may be included in the second network 199. The electronic device 101 may be applied to intelligent services (e.g., smart home, smart city, smart car, or healthcare) based on 5G communication technology or IoT-related technology.

The electronic device according to various embodiments may be one of various types of electronic devices. The electronic devices may include, for example, a portable communication device (e.g., a smartphone), a computer device, a portable multimedia device, a portable medical device, a camera, a wearable device, a home appliance, or the like. According to an embodiment of the disclosure, the electronic devices are not limited to those described above.

It should be appreciated that various embodiments of the present disclosure and the terms used therein are not intended to limit the technological features set forth herein to particular embodiments and include various changes, equivalents, or replacements for a corresponding embodiment. With regard to the description of the drawings, similar reference numerals may be used to refer to similar or related elements. It is to be understood that a singular form of a noun corresponding to an item may include one or more of the things, unless the relevant context clearly indicates otherwise. As used herein, each of such phrases as “A or B,” “at least one of A and B,” “at least one of A or B,” “A, B, or C,” “at least one of A, B, and C,” and “at least one of A, B, or C,” may include any one of, or all possible combinations of the items enumerated together in a corresponding one of the phrases. As used herein, such terms as “1st” and “2nd,” or “first” and “second” may be used to simply distinguish a corresponding component from another, and does not limit the components in other aspect (e.g., importance or order). It is to be understood that if an element (e.g., a first element) is referred to, with or without the term “operatively” or “communicatively”, as “coupled with,” “coupled to,” “connected with,” or “connected to” another element (e.g., a second element), the element may be coupled with the other element directly (e.g., wiredly), wirelessly, or via a third element.

As used in connection with various embodiments of the disclosure, the term “module” may include a unit implemented in hardware, software, or firmware, or any combination thereof, and may interchangeably be used with other terms, for example, “logic,” “logic block,” “part,” or “circuitry”. A module may be a single integral component, or a minimum unit or part thereof, adapted to perform one or more functions. For example, according to an embodiment, the module may be implemented in a form of an application-specific integrated circuit (ASIC).

Various embodiments as set forth herein may be implemented as software (e.g., the program 140) including one or more instructions that are stored in a storage medium (e.g., internal memory 136 or external memory 138) that is readable by a machine (e.g., the electronic device 101). For example, a processor (e.g., the processor 120) of the machine (e.g., the electronic device 101) may invoke at least one of the one or more instructions stored in the storage medium, and execute it, with or without using one or more other components under the control of the processor. This allows the machine to be operated to perform at least one function according to the at least one instruction invoked. The one or more instructions may include a code generated by a compiler or a code executable by an interpreter. The machine-readable storage medium may be provided in the form of a non-transitory storage medium. Wherein, the “non-transitory” storage medium is a tangible device, and may not include a signal (e.g., an electromagnetic wave), but this term does not differentiate between where data is semi-permanently stored in the storage medium and where the data is temporarily stored in the storage medium.

According to an embodiment, a method according to various embodiments of the disclosure may be included and provided in a computer program product. The computer program product may be traded as a product between a seller and a buyer. The computer program product may be distributed in the form of a machine-readable storage medium (e.g., compact disc read only memory (CD-ROM)), or be distributed (e.g., downloaded or uploaded) online via an application store (e.g., PlayStore™), or between two user devices (e.g., smart phones) directly. If distributed online, at least part of the computer program product may be temporarily generated or at least temporarily stored in the machine-readable storage medium, such as memory of the manufacturer's server, a server of the application store, or a relay server.

According to various embodiments, each component (e.g., a module or a program) of the above-described components may include a single entity or multiple entities, and some of the multiple entities may be separately disposed in different components. According to various embodiments, one or more of the above-described components may be omitted, or one or more other components may be added. Alternatively or additionally, a plurality of components (e.g., modules or programs) may be integrated into a single component. In such a case, according to various embodiments, the integrated component may still perform one or more functions of each of the plurality of components in the same or similar manner as they are performed by a corresponding one of the plurality of components before the integration. According to various embodiments, operations performed by the module, the program, or another component may be carried out sequentially, in parallel, repeatedly, or heuristically, or one or more of the operations may be executed in a different order or omitted, or one or more other operations may be added.

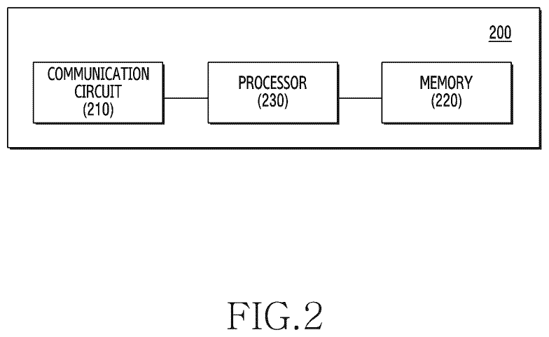

FIG. 2 is a block diagram illustrating an example configuration of an electronic device according to various embodiments.

Referring to FIG. 2, the electronic device 200 according to an embodiment of the disclosure may include a communication circuit 210, a memory 220, and a processor (e.g., including processing circuitry) 230. However, the components of the electronic device 200 are not limited thereto and the electronic device 200 may include some of the components of FIG. 2 described above, or may further include at least one other component (for example, an antenna module or a display module) in addition to the above-described components. For example, the electronic device 200 of FIG. 2 may correspond to the electronic device 101 of FIG. 1. Accordingly, the communication circuit 210 may correspond to the communication module 190 or the wireless communication module 192 of FIG. 1. In addition, the memory 220 and the processor 230 may correspond to the memory 130 and the processor 120 of FIG. 1, and, when the electronic device 200 further includes other components, the other component may also correspond to the components of FIG. 1. The description of the processor 120 above applies equally to the processor 210 and thus a redundant description thereof may not be repeated here.

The communication circuit 210 may support short-range wireless communication between the electronic device 200 and an external electronic device. For example, the communication circuit 210 may transmit and receive signals and/or data using a frequency band supported by wireless communication according to a wireless communication protocol prescribed with an external electronic device. In an embodiment, the communication circuit 210 may communicate with an external electronic device through a short-range wireless communication network such as ultra-wideband (UWB), Bluetooth, Bluetooth low energy, wireless fidelity (Wi-Fi) direct or infrared data association (IrDA). However, the short-range wireless communication network is not limited to the above-described examples, and various types of short-range wireless communication network may be used.

In an embodiment, the communication circuit 210 may include a UWB module. UWB refers to a wireless communication technique that uses a bandwidth of 500 MHz or more according to IEEE 802.15.4 standards, and may be used to measure accurate distances and angles due to its characteristic of using wide frequency bands. According to IEEE 802.15.4z standards, a scrambled timestamp sequence (STS) function may be introduced to prevent and/or block an external attacker from accessing UWB communication or forging in a physical layer, and to strengthen security and increase utilization.

The memory 220 may store instructions for operating the electronic device 200. At least one instruction may correspond to the program 140 of FIG. 1. The instructions may be executed through the processor 230, and the electronic device 200 may perform operations according to an embodiment of the disclosure by executing the instructions by the processor 230.

The processor 230 may include various processing circuitry and control at least one other component of the electronic device 200, and may perform various data processing or computations. For example, the processor 230 may execute instructions for controlling the communication circuit 210. The processor 230 may perform short-range wireless communication with an external electronic device by executing instructions for controlling the communication circuit 210.

In an embodiment, the processor 230 may perform positioning by executing instructions. More specifically, the processor 230 may perform operations of: acquiring distance information of a target electronic device at a plurality of measurement locations; acquiring first location information of the target electronic device based on the distance information; identifying accuracy of the first location information based on the plurality of measurement locations and the first location information; and determining a location of the target electronic device based on the accuracy of the first location information. Specific operations will be described hereinbelow in detail.

According to an embodiment, the operations described as being performed by the electronic device 200 may be understood as being performed by the processor 230.

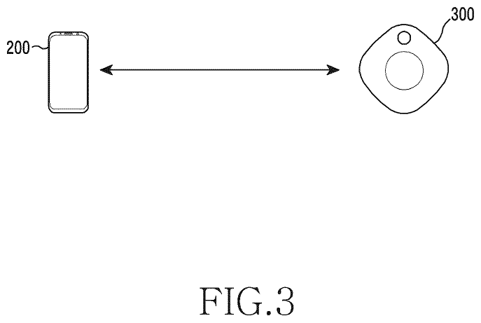

FIG. 3 is a diagram illustrating an example operation of measuring a distance between an electronic device and a target electronic device according to various embodiments.

The electronic device 200 may communicate with a target electronic device 300 using the communication circuit 210. The electronic device 200 may acquire a distance and/or a direction of the target electronic device 300 using signals received from at least one antenna. In this case, the electronic device 200 may connect to the target electronic device 300, first, and then, may perform the operation of measuring the distance and/or direction.

The target electronic device 300 may equally support short-range wireless communication supported by the electronic device 200. For example, when the electronic device 200 includes a UWB module and supports UWB communication, the target electronic device 300 may also include a UWB module and may support UWB communication, thereby communicating with the electronic device 200. In an embodiment, the target electronic device 300 may include a component for performing communication with the electronic device 200, for example, a processor and an antenna module. However, these are merely examples of the components of the target electronic device 300, and the components of the target electronic device 300 are not limited thereto and the target electronic device 300 may include some of the above-described components or may further include at least one other component in addition to the above-described components.

In an embodiment, the electronic device 200 may measure a distance to the target electronic device 300. For example, the electronic device 200 may estimate a distance from the target electronic device 300 based on a strength of a signal received from the target electronic device 300. The electronic device 200 may estimate a distance from the target electronic device 300 based on a transmission time of packets exchanged with the target electronic device 300.

In an embodiment, when the communication circuit 210 includes a UWB module, the electronic device 200 may measure a distance between the electronic device 200 and the target electronic device 300 using the UWB module. In this case, the electronic device 200 may measure a distance to the target electronic device 300 using such a method as single side two way ranging (SS-TWR) or double side two way ranging (DS-TWR), or may measure distances between the target electronic device 300 and a plurality of target electronic devices using such a method as uplink time difference of arrival (UL-TDoA), downlink time difference of arrival (DL-TDoA).

The electronic device 200 may connect to the target electronic device 300, first, in order to measure a distance between the electronic device 200 and the target electronic device 300, and may perform a distance measuring operation. In this case, connecting to the target electronic device 300 may use UWB communication. For example, the connecting operation may be performed using other communication methods such as Bluetooth, Bluetooth low energy, Wi-Fi direct, or IrDA. The electronic device 200 may recognize the target electronic device 300 through the connecting operation, and then, may perform the distance measuring operation.

According to an embodiment, using UWB communication has the advantages that a delay time is short and an error is very low, so that distances are precisely measured. However, this is merely an example of a method for the electronic device 200 to measure a distance to the target electronic device 300, and the electronic device 200 may measure a distance to the target electronic device 300 using various communication modules and communication techniques. For example, the electronic device 200 may measure a distance to the target electronic device 300 using Wi-Fi direct, Bluetooth, or IrDA.

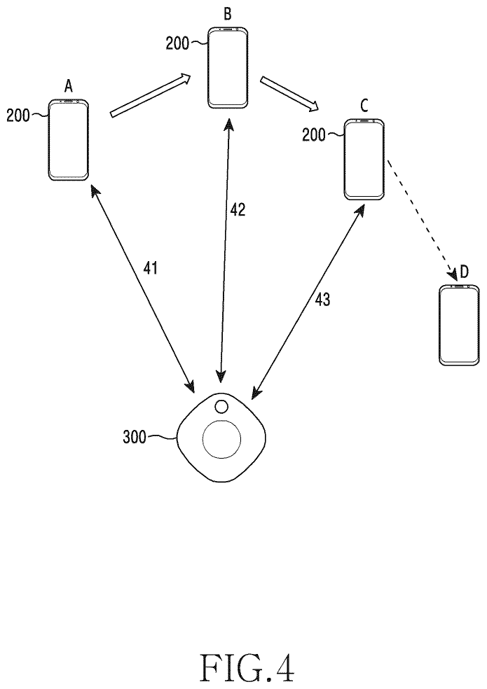

FIG. 4 is a diagram illustrating an example operation of determining a location of a target electronic device according to various embodiments.

Referring to FIG. 4, the electronic device 200 may move to an A location, a B location, a C location, and may measure a location (location at A, B, C) of the electronic device 200 and/or a distance 41, 42, 43 between the electronic device 200 and the target electronic device 300 at each measurement location.

In an embodiment, the electronic device 200 may acquire an absolute location (for example, absolute coordinates) and/or a relative location (for example, relative coordinates) of the electronic device 200 through various methods. For example, the electronic device 200 may include an augmented reality (AR) module (not shown), and may acquire a location of the electronic device 200 using the AR module. The AR module may include a camera and a sensor to perform the role of supporting augmented reality (AR). The AR module may include hardware such as a camera and a sensor independently, and may be configured using components of the electronic device 200 shown in FIG. 1. For example, the AR module may include a sensor module 176 and a camera module 180. In addition, the AR module may support AR using other components as software modules, such as the sensor module 176, the camera module 180.

The electronic device 200 may acquire an absolute location or a relative location of the electronic device 200 using an external electronic device that has relative coordinates or absolute coordinates already determined. In this case, the external electronic device may be explained with various names like an anchor, a GPS, or an external location device. The electronic device 200 may acquire a location of the electronic device 200 using various devices (for example, the sensor module 176, the camera module 180, the audio module 170, or a GPS module (not shown)) provided in the electronic device, in addition to the AR module.

In an embodiment, the electronic device 200 may measure an absolute location (for example, absolute coordinates) or a relative location (for example, relative coordinates) of the target electronic device 300 using a distance between the electronic device 200 and the target electronic device 300. In general, when the electronic device 200 measures distances between the electronic device 200 and the target electronic device 300 at three locations, the electronic device 200 may acquire 2D coordinates of the target electronic device 300, and, when the electronic device 200 measures distances between the electronic device 200 and the target electronic device 300 at four or more locations, the electronic device 200 may acquire 3D coordinates of the target electronic device 300.

Referring to FIG. 4, when the electronic device 200 measures the location of the electronic device 200 and measures the distance 43 between the electronic device 200 and the target electronic device 300 at the A location, B location, C location, the electronic device 200 may measure the location of the target electronic device 300.

When the distance between the electronic device 200 and the target electronic device 300 is measured at three locations as described above, the number of measurement may be minimized and/or reduced, so that the location of the target electronic device 300 may be measured fast, but accuracy may be reduced for various reasons. For example, distances may be incorrectly measured since appropriate signals may not be received due to obstacles on a specific path or the strength of a received signal may be reduced, and an error may increase according to arrangements of measurement locations where the electronic device 200 measures a distance to the target electronic device 300. For example, the distance 42 between the B location and the target electronic device 300 may be incorrectly measured due to a concrete wall between the B location and the target electronic device 300, or other devices using similar frequencies, or a meaningful measurement value may not be acquired. When the A location, B location, C location which are measurement locations where the electronic device 200 measures a distance to the target electronic device 300 are extremely close, or are biased toward one direction with reference to the target electronic device 300, an error may increase.

According to an embodiment of the disclosure, when it is determined that the accuracy of a measured location is low, a distance between the electronic device 200 and the target electronic device 300 may be measured at least one additional measurement location, so that the accuracy may increase. For example, the electronic device 200 may additionally measure a distance to the target electronic device 300 at a D location.

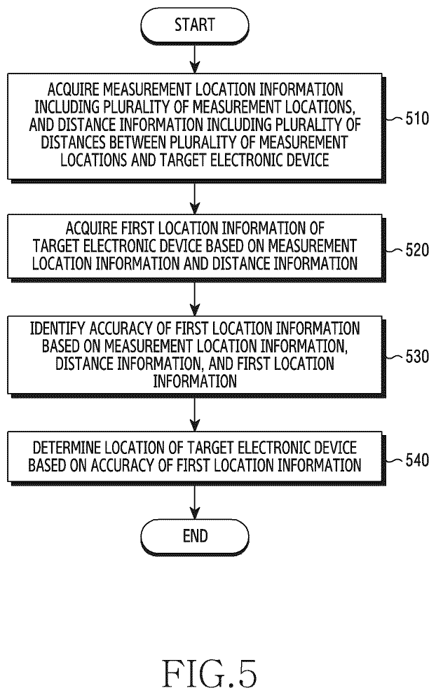

FIG. 5 is a flowchart illustrating an example method of operating an electronic device according to various embodiments.

In operation 510, the electronic device 200 may acquire measurement location information including a plurality of measurement locations, and distance information including a plurality of distances between the plurality of measurement locations and a target electronic device 300.

In an embodiment, the electronic device 200 may acquire location information on the plurality of measurement locations by measuring a location of the electronic device 200 at each measurement location. As described above, the electronic device 200 may acquire an absolute location (for example, absolute coordinates) and/or a relative location (for example, relative coordinates) of the electronic device 200 through various methods. For example, the electronic device 200 may include an AR module (not shown), and may acquire a location of the electronic device 200 using the AR module. The electronic device 200 may acquire an absolute location or a relative location of the electronic device 200 using an external electronic device that has relative coordinates or absolute coordinates already determined. In this case, the external electronic device may be explained with various names like an anchor, a GPS, or an external location device. The electronic device 200 may acquire a location of the electronic device 200 using various devices (for example, the sensor module 176, the camera module 180, the audio module 170, or a GPS module (not shown)) provided in the electronic device, in addition to the AR module.

In an embodiment, the electronic device 200 may acquire a plurality of distances between the plurality of measurement locations and the target electronic device 300 by measuring a distance between the electronic device 200 and the target electronic device 300 at each measurement location. In an embodiment, the electronic device 200 may acquire distance information of the target electronic device 300 based on short-range wireless communication. In this case, the electronic device 200 may perform short-range wireless communication with the target electronic device 300 using the communication circuit 210, and may acquire distance information. For example, when the electronic device 200 includes a UWB module, the electronic device 200 may measure a distance to the target electronic device 300 using UWB communication.

In this case, the electronic device 200 may measure a distance to the target electronic device 300 using such a method as single side two way ranging (SS-TWR) or double side two way ranging (DS-TWR), or may measure distances between the target electronic device 300 and a plurality of target electronic devices using such a method as uplink time difference of arrival (UL-TDoA), downlink time difference of arrival (DL-TDoA).

The electronic device 200 may connect to the target electronic device 300, first, in order to measure a distance between the electronic device 200 and the target electronic device 300, and may perform a distance measuring operation. In this case, connecting to the target electronic device 300 may use UWB communication. For example, the connecting operation may be performed using other communication methods such as Bluetooth, Bluetooth low energy, Wi-Fi direct, or IrDA. The electronic device 200 may recognize the target electronic device 300 through the connecting operation, and then, may perform the distance measuring operation.

According to an embodiment, using UWB communication has the advantages that a delay time is short and an error is very low, so that distances are precisely measured. However, this is merely an example of a method for the electronic device 200 to measure a distance to the target electronic device 300, and the electronic device 200 may measure a distance to the target electronic device 300 using various communication modules and communication techniques. For example, the electronic device 200 may measure a distance to the target electronic device 300 using Wi-Fi direct, Bluetooth, or IrDA.

In an embodiment, the electronic device 200 may acquire a first location of the electronic device 200 and a first distance between the electronic device 200 and the target electronic device 300 at a first measurement location, may move to a second measurement location different from the first measurement location and may acquire a second location of the electronic device 200 and a second distance between the electronic device 200 and the target electronic device 300 at the second measurement location, and may move to a third measurement location different from the first measurement location and the second measurement location, and may acquire a third location of the electronic device 200 and a third distance between the electronic device 200 and the target electronic device 300 at the third measurement location.

In this case, the measurement location information may include the first location, the second location, and the third location. For example, the electronic device 200 may acquire the first location at the first measurement location and may store the measurement location information in the memory 130, may move to the second measurement location, acquire the second location, add the second location to the measurement location information, and may store the measurement location information in the memory 130, and may move to the third measurement location, may acquire the third location, may add the third location to the measurement location information, and may store the measurement location information in the memory 130.

The distance information may include the first distance, the second distance, and the third distance. For example, the electronic device 200 may acquire the first distance at the first measurement location and may store the distance information in the memory 130, may move to the second measurement location, acquire the second distance, add the second location to the distance information, and may store the distance information in the memory 130, and may move to the third measurement location, may acquire the third distance, may add the third distance to the distance information, and may store the distance information in the memory 130.

According to an embodiment, the electronic device may acquire a location of the electronic device 200 and a distance between the electronic device 200 and the target electronic device 300 at an additional measurement location, for example, a fourth location, a fifth location, . . . , and a M-th location (where M is a natural number).

In an embodiment, the operation of measuring a location of the electronic device 200 at one measurement location, and the operation of measuring a distance between the electronic device 200 and the target electronic device 300 may be performed in sequence or simultaneously. For example, after the location of the electronic device 200 is measured, the distance between the electronic device 200 and the target electronic device 300 may be measured, or, after the distance between the electronic device 200 and the target electronic device 300 is measured, the location of the electronic device 200 may be measured, or the location of the electronic device 200 and the distance between the electronic device 200 and the target electronic device 300 may be measured simultaneously.

In an embodiment, the plurality of measurement locations may include at least a part of the locations for acquiring location information of the electronic device 200. That is, the electronic device 200 may measure a location of the electronic device 200 at the plurality of measurement locations for measuring a distance between the electronic device 200 and the target electronic device 300. When the electronic device 200 acquires the electronic device 200's own location at N locations and measures a distance to the target electronic device 300 at M measurement locations, the M measurement locations may be a part of the N locations (M, N are natural numbers).

For example, when the electronic device 200 includes an AR module and a UWB module, acquires a location of the electronic device 200 using the AR module, and measures a distance between the electronic device 200 and the target electronic device 300 using the UWB module, the electronic device 200 may measure the distance between the electronic device 200 and the target electronic device 300 using the UWB module at some of the locations where the electronic device 200 acquires the location of the electronic device 200 using the AR module. In this case, the locations for acquiring location information of the electronic device 200 may be determined based on a sampling rate of an operation of photographing and/or sensing for the AI module to acquire the location information of the electronic device. In addition, the measurement location for measuring a distance between the electronic device 200 and the target electronic device 300 may be determined based on a sampling rate of an operation of measuring a distance for the UWB module to measure a distance between the electronic device 200 and the target electronic device 300. In this case, the UWB module may measure a distance between the electronic device 200 and the target electronic device 300 based on a sampling rate of the least common multiple of the sampling rate of the AR module and the sampling rate of the UWB module.

In an embodiment, the plurality of measurement locations may be arranged at a predetermined distance or more. For example, the electronic device 200 may acquire a location of the electronic device 200 and a distance between the electronic device 200 and the target electronic device 300 at one measurement location, and then, may move by a predetermined distance or more and may acquire a location of the electronic device 200 and a distance between the electronic device 200 and the target electronic device 300. For example, the first measurement location and the second measurement location may be spaced apart from each other by 20 cm or more.

In an embodiment, the operation of acquiring a location of the electronic device 200 and the operation of acquiring a distance between the electronic device 200 and the target electronic device 300 may be performed in parallel by the electronic device 200. For example, the electronic device 200 may acquire a location of the electronic device 200 using the AR module and may acquire a distance between the electronic device 200 and the target electronic device 300 using the UWB module. For example, the electronic device 200 may measure the location of the electronic device 200 according to an operating cycle or a sampling rate of the AR module, while measuring the distance between the electronic device 200 and the target electronic device 300 according to an operating cycle or a sampling rate of the UWB module. In this case, the operating cycle of the AR module may be shorter than the operating cycle of the UWB module. For example, the operating cycle of the AR module may be very short, about 1 ms, and the operating cycle of the UWB module may be relatively long, about 200 ms. Accordingly, the electronic device 200 may measure a location of the electronic device 200 every 1 ms in the middle of measuring a distance every 200 ms with the UWB module. Every time the electronic device 200 measures a distance with the UWB module, the electronic device 200 may identify a location where a distance is previously measured, and may measure a distance when the previously identified location is 20 cm or more away.

In an embodiment, as the number of measurements increases and the distance between measurement locations increases, the accuracy may increase, but, when the number of measurements increases or the distance between the measurement locations increases, a delay may occur in the overall location measuring operation. According to an embodiment of the disclosure, faster measurement speed and higher accuracy may be provided by minimizing the number of measurements. This will be described in more detail below.

In operation 520, the electronic device 200 may acquire first location information of the target electronic device 300 based on the measurement location information and the distance information. The first location information may include an initial location of the target electronic device 300 that is measured by the electronic device 200. In general, when the electronic device 200 measures a distance between the electronic device 200 and the target electronic device 300 at three locations, the electronic device 200 may acquire 2D coordinates of the target electronic device 300, and, when the electronic device 200 measures a distance between the electronic device 200 and the target electronic device 300 at four or more locations, the electronic device 200 may acquire 3D coordinates of the target electronic device 300. For example, the electronic device 200 may measure an absolute location (for example, absolute coordinates) or a relative location (for example, relative coordinates) of the target electronic device 300 through trilateration. However, this should not be considered as limiting, and the electronic device 200 may measure a location of the target electronic device 300 in various methods.

In an embodiment, the first location information may include a relative location or an absolute location with reference to the measurement location information, e.g., the plurality of measurement locations. That is, the location of the target electronic device 300 may be indicated by a relative location with respect to the plurality of measurement locations. In this case, when an absolute location for the plurality of measurement locations is known, the location of the target electronic device 300 may also be indicated by an absolute location or a relative location with respect to the plurality of measurement locations. In contrast, when a relative location for the plurality of measurement locations with respect to a reference location is known, the location of the target electronic device 300 may also be indicated by a relative location.

In operation 530, the electronic device 200 may identify accuracy of the first location information based on the measurement location information, the distance information, and the first location information. In an embodiment, the electronic device 200 may acquire a dilution of precision (DoP) value based on the distance information and the first location information, and may identify the accuracy of the first location information based on the DoP value.

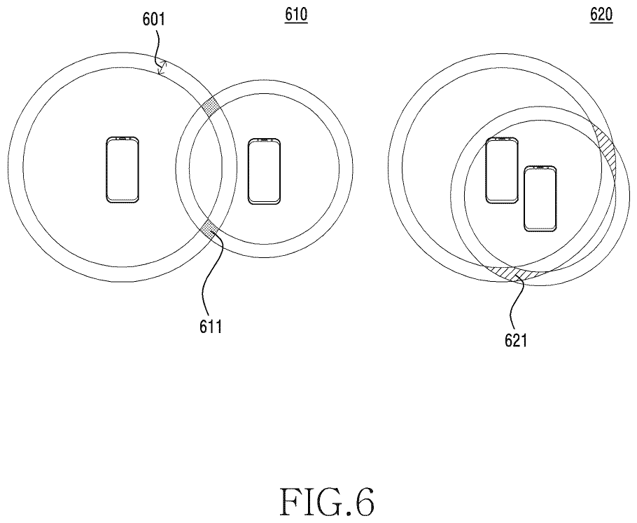

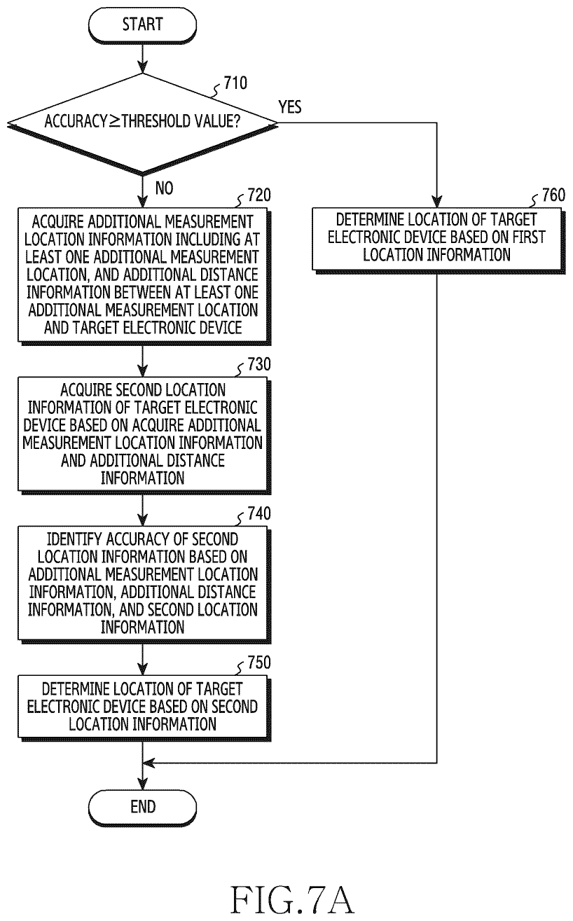

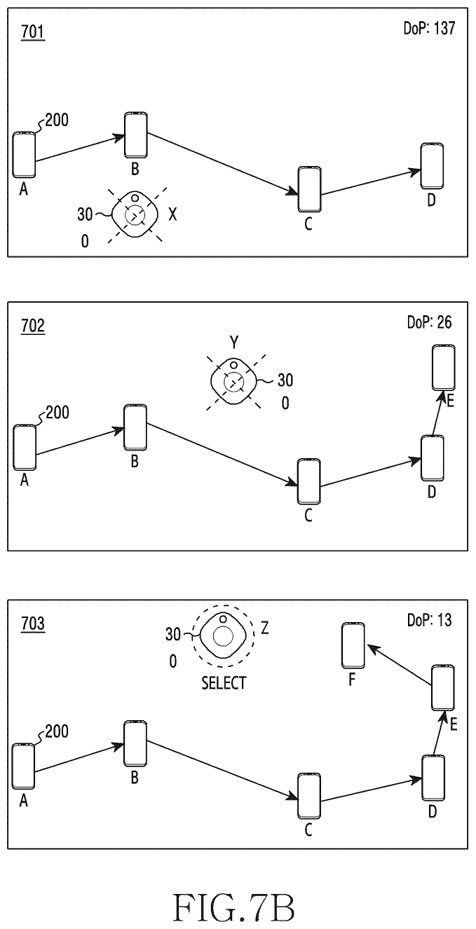

DoP is a concept that mathematically indicates location measurement precision according to a geographical location of an artificial satellite when acquiring a distance or a distance difference between a device receiving signals from a surrounding artificial satellite through GPS, and the artificial satellite. That is, DoP is a parameter that represents location measurement precision varying according to arrangement of artificial satellites, and as the DoP value is lower, the location measurement precision is higher, and, as the DoP value is larger, the location measurement precision is lower. In an embodiment of the disclosure, by adopting the DoP concept, the accuracy of a location of the target electronic device 300 measured may be identified. For example, the electronic device 200 may identify the accuracy of a measurement location that varies according to arrangements of the plurality of measurement locations where a distance to the target electronic device 300 is measured. DoP will be described in greater detail below with reference to FIGS. 6, 7A, and 7B.

FIG. 6 is a diagram illustrating example dilution of precision (DoP) according to various embodiments.

Referring to FIG. 6, each circle indicates a distance to a target electronic device that is measured by an electronic device, and a thickness 601 of the circle indicates a measurement error of the electronic device. In FIG. 6, it is assumed that locations are measured using the same electronic device, and hence, the same measurement error occurs. Areas where distances measured by the electronic device at two measurement locations overlap each other, that is, areas 611, 621 where two circles overlap each other, may correspond to areas where a target electronic device exists. Accordingly, as the area where two circles overlap each other is narrower, the area where a target electronic device exists is narrower, and the precision of location measurement is higher.

610 and 620 indicate operations of the electronic device measuring a location at two different locations. Even though the same device measures locations for the target electronic device through two location measurements at two locations, the size of the area where the target electronic device exists varies according to change in the arrangement of the measurement locations. For example, the area 621 where two circles overlap each other when a location is measured at two measurement locations of 620 may be larger than the area 611 where two circles overlap each other when a location is measured at two measurement locations of 610. That is, the precision may vary according to the arrangement of measurement locations where the electronic device measures locations.

In an embodiment of the disclosure, the electronic device 200 may identify the accuracy of a location of the target electronic device 300 measured using a DoP value.

The DoP value may be defined by Equation 1 presented below:

$$D = \sqrt{t r ( {H}^{T} {H}^{- 1} )} \qquad [ Equation 1 ]$$

$$where H = [ \begin{matrix}{e}_{11} & {e}_{12} & {e}_{13} & 1 \\ {e}_{21} & {e}_{22} & {e}_{23} & 1 \\ … & … & … & … \\ {e}_{n 1} & {e}_{n 2} & {e}_{n 3} & 1\end{matrix} ] \cdot {e}_{i 1} = \frac{\hat{x} - {X}_{i}}{{\hat{r}}_{i}} , {e}_{i 2} = \frac{\hat{y} - {Y}_{i}}{{\hat{r}}_{i}} , {e}_{i 3} = \frac{\hat{z} - {Z}_{i}}{{\hat{r}}_{i}} ,$$

$$and$$

$${\hat{r}}_{i} = \sqrt{{( \hat{x} - {X}_{i} )}^{2} + {( \hat{y} - {y}_{i} )}^{2} + {( \hat{z} - {Z}_{i} )}^{2}}$$

Here, D is a DoP value, tr ( ) is a trace operation of a matrix, ( )^{T} is a transpose operation of a matrix, and ( ) 1 is an inverse matrix operation. In addition, (x, y, z) is a location of the target electronic device 300, and (Xᵢ, Yᵢ, Zᵢ) indicate a measurement location of the electronic device 200. rᵢ indicates a distance between the electronic device 200 and the target electronic device 300. \hat{r}ᵢ indicates an approximate location of the target electronic device 300, and may refer to the first location information, e.g., the initial location of the target electronic device 300 that is measured by the electronic device 200 in an embodiment.

According to an embodiment of the disclosure, as the DoP value calculated by Equation 1 is smaller, the accuracy of a location of the target electronic device 300 measured by the electronic device 200 is higher, and, as the DoP value is larger, the accuracy of a location of the target electronic device 300 measured by the electronic device 200 is lower. For example, the accuracy has a reciprocal relationship with the DoP value.

According to an embodiment, the electronic device 200 may acquire a measurement location that makes the DoP value smaller, that is, increases the accuracy through Equation 1. In an embodiment, the electronic device 200 may acquire preference measurement location information related to the measurement location that increases the accuracy, and may output the same. According to an embodiment of the disclosure, the electronic device 200 may determine a location of the target electronic device 300 by additionally measuring a distance to the target electronic device 300 at an additional measurement location that increases the accuracy, based on the outputted preference measurement location information, so that high accuracy may be provided with the minimal number of measurements.

Referring back to FIG. 5, in operation 530, the electronic device 200 may identify the accuracy of the first location information based on the distance between the electronic device 200 and the target electronic device 300, whether the electronic device 200 and the target electronic device 300 are in a line of sight (LOS) environment, and the strength of a measured signal. As the distance between the electronic device 200 and the target electronic device 300 is longer, the accuracy of the first location information may be lower. When the electronic device 200 and the target electronic device 300 are in the LOS environment, the accuracy may be higher, and, when the electronic device 200 and the target electronic device 300 are in a non-LOS environment, the accuracy may be lower. According to an embodiment, the electronic device 200 may identify whether the electronic device 200 and the target electronic device 300 are in the LOS environment or in the non-LOS environment by comparing a signal measured at a previous measurement location and a signal measured at a current measurement location. For example, when a signal strength is abruptly reduced compared to a previously received signal, the electronic device 200 may determine that the electronic device 200 and the target electronic device 300 are in the non-LOS environment. When the strength of a measured signal is strong, the accuracy may be high, and, when the strength of a measured signal is weak, the accuracy may be low. In an embodiment, when identifying the accuracy of the first location information, the electronic device 200 may identify the accuracy by reflecting a distance between the electronic device 200 and the target electronic device 300, whether the electronic device 200 and the target electronic device 300 are in the LOS environment, and the strength of a measured signal.

In operation 540, the electronic device 200 may determine a location of the target electronic device 300 based on the accuracy of the first location information. In an embodiment, the electronic device 200 may determine a location of the target electronic device 300 by additionally measuring a distance to the target electronic device 300 at an additional measurement location based on the accuracy of the first location information. The operation of determining a location of the target electronic device 300 will be described in greater detail below with reference to FIGS. 7A and 7B.

FIGS. 7A and 7B are a flowchart and a diagram illustrating an example operation of determining a location of the target electronic device based on the accuracy of the first location information according to various embodiments.

FIG. 7A is a flowchart illustrating operation 540 of FIG. 5 in greater detail according to various embodiments.

In operation 710, the electronic device 200 may compare the accuracy of the first location information and a threshold value. In an embodiment, the accuracy of the first location information may be identified based on a DoP value. In this case, the accuracy may have a reciprocal relationship with the DoP value.

When the electronic device 200 determines that the accuracy of the first location information is less than the threshold value in operation 710, the electronic device 200 may perform operation 720. For example, when the DoP value is larger than 20, the electronic device 200 may determine that the accuracy of the first location information is smaller than the threshold value. Value 20 is an example value and the DoP value for determining the accuracy may vary according to requirements of a device, a system, an application, a program or a function for requesting the location of the target electronic device 300.

In operation 720, the electronic device 200 may acquire additional measurement location information including at least one additional measurement location, and additional distance information between the at least one additional measurement location and the target electronic device 300. In this case, the operation of acquiring the additional measurement location information and the additional distance information may use the operation of acquiring the measurement location and the distance information in operation 510. For example, the electronic device 200 may acquire an additional measurement location using various devices provided in the electronic device 200, such as the AR module, the sensor module 176, the camera module 180, the audio module 170, or the GPS module (not shown), and, when the electronic device 200 includes a UWB module, the electronic device 200 may acquire additional distance information to the target electronic device 300 using UWB communication. The additional measurement location may include at least a part of the locations for acquiring location information of the electronic device 200.

According to an embodiment, as the additional distance information is acquired at the additional measurement location, the number of measurements may increase and the accuracy may increase. However, the number of measurements increases, causing a delay in the overall location measurement operation, but according to an embodiment of the disclosure, the additional distance information may be acquired at the additional measurement location when the accuracy of the first location information, for example, of the initial location of the target electronic device 300 measured by the electronic device 200, is less than the threshold value, so that the number of measurements may be minimized and/or reduced and fast measurement speed and high accuracy may be provided.

The electronic device 200 may acquire a measurement location for making the DoP value smaller, e.g., for increasing the accuracy, through Equation 1. In an embodiment, the electronic device 200 may acquire preference measurement location information related to a measurement location that increases the accuracy, and may output the same. The electronic device 200 may acquire the preference measurement location information using a non-linear least square method, an extended Kalman filter, for example.

According to an embodiment of the disclosure, the electronic device 200 may determine a location of the target electronic device 300 by additionally measuring a distance to the target electronic device 300 at the additional measurement location where the accuracy may be improved, based on the outputted preference measurement location information, so that high accuracy may be provided with the minimal number of measurements.

In this case, the electronic device 200 may output the preference measurement location information in various methods and may provide the same to a user. For example, the electronic device 200 may display the preference measurement location information as a figure and/or a text using the display module 160, and may output the preference measurement location information as a voice signal through the audio module 170. The electronic device 200 may deliver the preference measurement location information to other external electronic devices through the communication module 190.

In operation 730, the electronic device 200 may acquire second location information of the target electronic device 300 based on the additional measurement location information and the additional distance information which are acquired in operation 720. According to an embodiment, the second location information may be acquired by measuring at more locations than when the first location information, for example, the initial location of the target electronic device 300 measured by the electronic device 200, is acquired, so that the second location information with higher accuracy than the first location information may be provided.

In an embodiment, when acquiring the second location information, the electronic device 200 may acquire the second location information using the information used for acquiring the first location information, for example, the measurement location information and the distance information, or only a part thereof all together. For example, the electronic device 200 may acquire the first location information by acquiring measurement location information and distance information at a first measurement location, a second measurement location, and a third measurement location, and may acquire additional measurement location information and additional distance information at a fourth measurement location, a fifth measurement location, and a sixth measurement location. In this case, when acquiring the second location information, the electronic device 200 may acquire the second location information using the measurement location information and the additional distance information which are acquired at the fourth measurement location, the fifth measurement location, and the sixth measurement location when acquiring the second location information, or may acquire the second location information using the measurement location information and the distance information at the first measurement location, the second measurement location, and the third measurement location, and the measurement location information and the additional distance information which are acquired at the fourth measurement location, the fifth measurement location, and the sixth measurement location, or may acquire the second location information using the measurement location information and the distance information at the third measurement location, and the measurement location information and the additional distance information which are acquired at the fourth measurement location, the fifth measurement location, and the sixth measurement location.

According to an embodiment, the electronic device 200 may exclude older information in sequence, and may acquire the second location information using only relatively recently acquired information, and, when it is determined that the accuracy is excessively low, the electronic device 200 may acquire the second location information using newly acquired information.

In operation 740, the electronic device 200 may identify accuracy of the second location information based on the additional measurement location information, the additional distance information, and the second location information. In an embodiment, the electronic device 200 may acquire a dilution of precision (DoP) value based on the plurality of measurement locations, the additional measurement location, and the second location information, and may identify the accuracy of the second location information based on the DoP value. For example, the electronic device 200 may identify the accuracy of the second location information, based on the distance between the electronic device 200 and the target electronic device 300, whether the electronic device 200 and the target electronic device 300 are in a line of sight (LOS) environment, and a strength of a measured signal.

In an embodiment, when the electronic device 200 acquires the second location information using the information used for acquiring the first location information, for example, the measurement location information and the distance information, or only a part thereof all together in operation 730, the electronic device 200 may use the information used for acquiring the second location information in operation 730 all together when identifying the accuracy of the second location information in operation 740.

In operation 750, the electronic device 200 may determine a location of the target electronic device 300 based on the accuracy of the second location information.

In an embodiment, the electronic device 200 may repeat operations 710 to 740 based on the accuracy of the second location information which is identified in operation 740. For example, when it is determined that the identified accuracy of location information of the electronic device 200 is smaller than a threshold value, the electronic device 200 may increase the accuracy of the location information of the electronic device 200 by repeating operations 720 to 750.

When the electronic device 200 determines that the accuracy of the first location information is larger than or equal to the threshold value in operation 710, the electronic device 200 may perform operation 760. For example, when the DoP value is less than or equal to 20, the electronic device 200 may determine that the accuracy of the first location information is larger than or equal to the threshold value.

In operation 760, the electronic device 200 may determine a location of the target electronic device based on the first location information acquired in operation 520. For example, when the initial location of the target electronic device 300 has accuracy greater than or equal to the threshold value, the electronic device 200 may determine the initial location as the location of the target electronic device 300. The electronic device 200 may determine the location of the target electronic device 300 as an absolute location (for example, absolute coordinates) or a relative location (for example, relative coordinates).

According to an embodiment, the electronic device 200 may provide high accuracy with the minimal number of measurements by repeating the above-described operations. However, the electronic device 200 may limit the number of times of repeating the operations to prevent and/or reduce a delay from occurring in the overall location measurement operation due to an excessively increased number of measurements. For example, the electronic device 200 may limit the number of operations of acquiring additional distance information or may limit the number of times of identifying the accuracy, and, when the operations are performed predetermined number of times or more, the electronic device 200 may determine the location of the target electronic device based on the last location information of the target electronic device.

Operations 510 to 540 of FIG. 5, operations 710 to 760 of FIG. 7A may be executed sequentially, in parallel, repeatedly, or heuristically, or one or more of the above-described operations may be executed in a different order or omitted or one or more other operations may be added.

FIG. 7B is a diagram illustrating example operations of the flowchart of FIG. 7B according to various embodiments.

Referring to FIG. 7B, in step 701, the electronic device 200 may move to an A location, a B location, a C location, and a D location, and may determine an X location as a location of the target electronic device 300 using a location of the electronic device 200 and a distance between the electronic device 200 and the target electronic device 300 at each measurement location. The electronic device 200 may acquire accuracy of the X location based on the plurality of measurement locations (A location, B location, C location, D location), the distance between the electronic device 200 and the target electronic device 300 at each measurement location, and the location of the target electronic device 300 acquired. In this case, the electronic device 200 may acquire the accuracy of the location of the target electronic device 300 using a DoP value described above. In FIG. 7B, determining accuracy with reference to the DoP value of 20 will be described in greater detail.

Since the DoP value calculated by the electronic device 200 in step S701 is 137, the electronic device 200 may determine that the accuracy of the X location is smaller than a threshold value, and may measure a location of the electronic device 200 and a distance between the electronic device 200 and the target electronic device 300 at an additional measurement location. In this case, the electronic device 200 may acquire preference measurement location information related to a measurement location where the accuracy may be improved, and may output the same. For example, the electronic device 200 may determine an E location as the preference measurement location, and may provide the E location to a user using the display module 160 and/or other internal devices or modules.

In step 702, the electronic device 200 may move to the E location and may measure a location of the electronic device 200 and a distance between the electronic device 200 and the target electronic device 300 at the location. For example, the electronic device 200 may acquire additional measurement location information at the E location and additional distance information between the E location and the target electronic device 300. The electronic device 200 may determine a Y location as the location of the target electronic device 300 using the plurality of measurement locations (A location, B location, C location, D location), the distance between the electronic device 200 and the target electronic device 300 at each measurement location, the location of the electronic device 300 acquired, additional measurement location (E location), and the additional distance between the E location and the target electronic device 300. It is illustrated that all pieces of information used for determining the X location are used when the Y location is determined in step 702, but this should not be considered as limiting. A part of the information, for example, the B location, C location, D location except for the A location, the distance to the target electronic device 300 at the corresponding location, the additional measurement location (E location), and the distance to the target electronic device 300 at the additional measurement location (E location) may be used. In addition, when the location of the electronic device 200 and the additional distance between the electronic device 200 and the target electronic device 300 are acquired at a sufficient number of additional measurement locations, it may be possible to determine the Y location only using the additional measurement location and the additional distance.

Since the DoP value calculated by the electronic device 200 in step 702 is 26, the electronic device 200 may determine that the accuracy of the Y location is less than the threshold value and may determine a location of the electronic device 200 and a distance between the electronic device 200 and the target electronic device 300 at an additional measurement location. In this case, the electronic device 200 may acquire preference measurement location information related to a measurement location where the accuracy is improved as in step 701, and may output the same. For example, the electronic device 200 may determine an F location as the preference measurement location, and may provide the F location to the user using the display module 160 and/or other internal devices or modules.

In step 703, the electronic device 200 may move to the F location and may measure a location of the electronic device 200 and a distance between the electronic device 200 and the target electronic device 300 at the location. That is, the electronic device 200 may acquire additional measurement location information at the F location and additional distance information between the F location and the target electronic device 300. The electronic device 200 may determine a Z location as the location of the target electronic device 300 using the plurality of measurement locations (A location, B location, C location, D location), the distance between the electronic device 200 and the target electronic device 300 at each measurement location, the location of the electronic device 300 acquired, additional measurement location (E location, F location), and the additional distance between each additional measurement location and the target electronic device 300.

Since the DoP value calculated by the electronic device 200 in step 703 is 13, the electronic device 200 may determine that the accuracy of the Z location is greater than the threshold value and may determine the Z location as the location of the target electronic device 300.

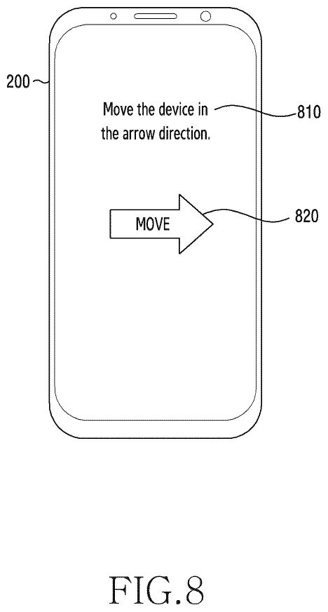

FIG. 8 is a diagram illustrating an example operation of outputting measurement location information according to various embodiments.

In an embodiment, the electronic device 200 may output a measurement location to induce a user of the electronic device 200 or the electronic device 200 to move to the corresponding measurement location. In an embodiment, the electronic device 200 may output a preference measurement location. In an embodiment, when the electronic device 200 determines that the accuracy of the first location information is smaller than the threshold value, the electronic device 200 may display a preference measurement location with a text 810 and an arrow 820 in order to induce the user to move to an additional measurement location that improves the accuracy.

Referring to FIG. 8, the electronic device 200 may indicate the measurement location or the preference measurement location with the text and the arrow using the display module 160. FIG. 8 illustrates the electronic device 200 displaying both the text and the arrow, but this should not be considered as limiting, and only one of the text 810 or the arrow 820 may be displayed and other figures than the arrow 820 may be displayed. According to an embodiment, it is possible to output preference measurement location information in other methods described above in addition to the method of displaying the preference measurement location with the text 810 and the arrow 820 using the display module 160. The electronic device is not limited to the above-described embodiments and may output the preference measurement location information in various methods.

In an embodiment, when the user of the electronic device 200 or the electronic device 200 moves to the measurement location or the preference measurement location, the electronic device 200 may measure a location of the electronic device 200 and may measure a distance between the electronic device 200 and the target electronic device 300 at the corresponding measurement location or the corresponding preference measurement location, and may store the same measurement location information and distance information.

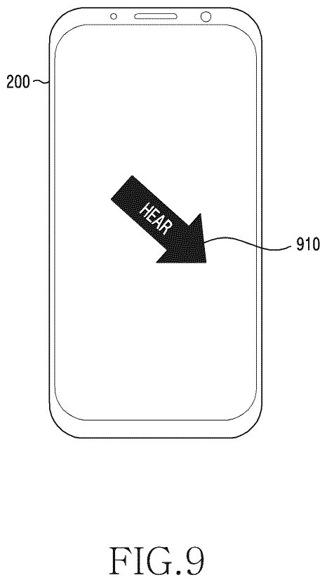

FIG. 9 is a diagram illustrating an example operation of outputting a location of a target electronic device according to various embodiments.

In an embodiment, the electronic device 200 may output a location of the target electronic device through the electronic device 200 in order to provide the location of the target electronic device 300 to a user. In this case, the electronic device 200 may output the location of the target electronic device in various methods and may provide the same to the user.

Referring to FIG. 9, the electronic device 200 may indicate the location of the target electronic device with an arrow 910 including a text using the display module 160. FIG. 9 illustrates the electronic device 200 displaying the arrow 910 including the text, but this should not be considered as limiting. Only one of the text or arrow may be displayed, and other figures than the arrow may be displayed. For example, it is possible to output the location of the target electronic device in other methods described above in addition to the method of displaying the location of the target electronic device with the text and the arrow using the display module 160. The electronic device 200 is not limited to the above-described embodiments and may output the location of the target electronic device in various methods.

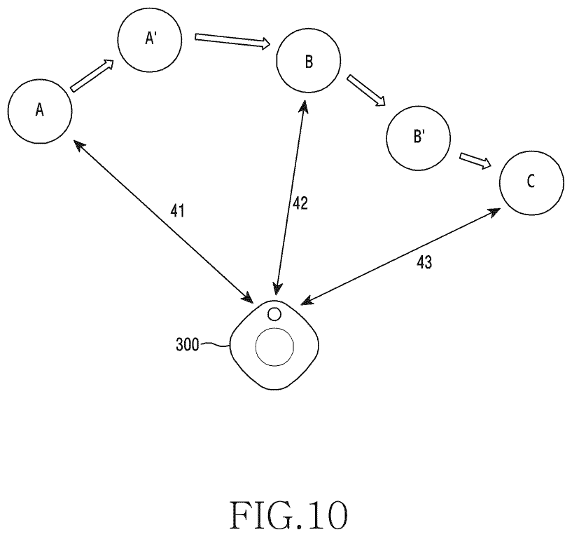

FIG. 10 is a diagram illustrating an example operation of acquiring location information and distance information of an electronic device according to various embodiments.

Referring to FIG. 10, the electronic device 200 may move to an A location, an A′ location, a B location, a B′ location, and a C location, and may perform an operation for determining a location of the target electronic device 300. In an embodiment, the electronic device 200 may acquire a location of the electronic device 200 and a distance between the electronic device 200 and the target electronic device 300 at one measurement location, and then, may move by a predetermined distance or more, and may acquire a location of the electronic device 200 and a distance between the electronic device 200 and the target electronic device 300. As described above, the electronic device 200 may determine the accuracy of a location of the target electronic device 300 acquired using a DoP value, and, since when the measurement locations are extremely close, the DoP value may be high, and accordingly, the electronic device 200 may be guided to move by a predetermined distance or more, or may measure a location of the electronic device 200 and a distance to the target electronic device 300 at a predetermined distance or more.

When the electronic device 200 measures a distance between the electronic device 200 and the target electronic device 300 at three locations, the electronic device 200 may acquire 2D coordinates of the target electronic device 300, and, when the electronic device 200 measures a distance between the electronic device 200 and the target electronic device 300 at four or more locations, the electronic device 200 may acquire 3D coordinates of the target electronic device 300.

In FIG. 10, the electronic device 200 may acquire a location of the electronic device 200 and a distance 41, 42, 43 to the target electronic device 300 at three locations that are spaced apart from one another by a predetermined distance or more, that is, the A location, B location, C location, in order to determine a location of the target electronic device 300.

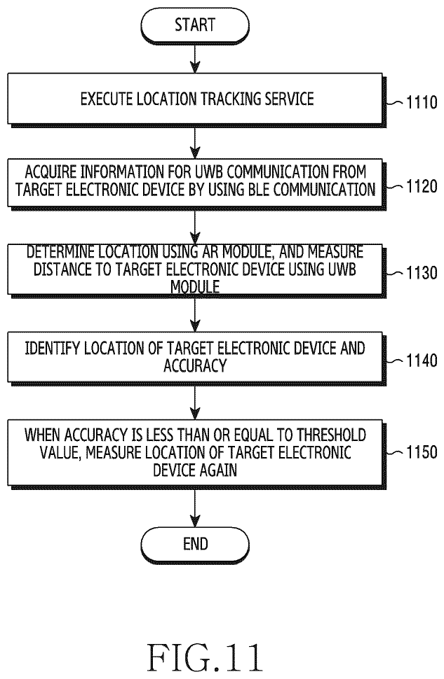

FIG. 11 is a flowchart illustrating an example method of operating an electronic device according to various embodiments.

In operation 1110, the electronic device 200 may execute a location tracking service. The electronic device 200 may execute the location tracking service according to a user input, a device, a system, an application, a program or a function that requests a location of the target electronic device 300.

In operation 1120, the electronic device 200 may acquire information for UWB communication from the target electronic device 300 using BLE communication. The electronic device 200 may perform a connecting operation to perform UWB communication with the target electronic device 300 based on the acquired information. The electronic device 200 may recognize the target electronic device 300 through the connecting operation, and then, may perform a distance measuring operation using a UWB module.

In operation 1130, the electronic device 200 may determine a location of the electronic device 200 using an AR module, and may measure a distance between the electronic device 200 and the target electronic device 300 using the UWB module.

In operation 1140, the electronic device 200 may identify a location of the target electronic device 300 and accuracy. The electronic device 200 may determine the location of the target electronic device 300 using the location of the electronic device 200 and the distance between the electronic device 200 and the target electronic device 300 which are measured in operation 1130. The accuracy of the location of the target electronic device 300 may be determined based on the location of the electronic device 200 and the distance between the electronic device 200 and the target electronic device 300, and the location of the target electronic device 300 determined.

In operation 1150, when the accuracy of the location of the target electronic device 300 is less than or equal to a threshold value, the electronic device 200 may measure the location of the target electronic device 300 again. In this case, the electronic device 200 may improve the accuracy by determining the location of the target electronic device 300 by repeating operations 1130 and 1140.

According to an embodiment of the disclosure, the number of measurements may be minimized and/or reduced so that fast measurement speed and high accuracy may be provided.

According to an example embodiment of the disclosure, an operating method of an electronic device may include: acquiring measurement location information which includes a plurality of measurement locations, and distance information which includes a plurality of distances between the plurality of measurement locations and a target electronic device; acquiring first location information of the target electronic device based on the measurement location information and the distance information; identifying an accuracy of the first location information based on the measurement location information, the distance information, and the first location information; and determining a location of the target electronic device based on the accuracy of the first location information.

In an example embodiment, determining the location of the target electronic device may include: when the accuracy is smaller than a threshold value, acquiring additional measurement location information which includes at least one additional measurement location, and additional distance information which includes at least one distance between the at least one additional measurement location and the target electronic device; acquiring second location information of the target electronic device based on the additional measurement location information and the additional distance information; identifying an accuracy of the second location information based on the additional measurement location information, the additional distance information, and the second location information; and determining the location of the target electronic device based on the second location information.

In an example embodiment, the operating method may further include: acquiring preference measurement location information related to a measurement location where it is possible to improve the accuracy; and outputting the preference measurement location information.

In an example embodiment, determining the location of the target electronic device based on the accuracy of the first location information may include, when the accuracy is greater than or equal to a threshold value, determining the location of the target electronic device based on the first location information.

In an example embodiment, identifying the accuracy of the first location information may include: acquiring a dilution of precision (DoP) value based on the distance information and the first location information; and identifying the accuracy of the first location information based on the DoP value.

In an example embodiment, identifying the accuracy of the first location information may include identifying the accuracy of the first location information based on at least one of a distance between the electronic device and the target electronic device, whether the electronic device and the target electronic device are in a line of sight (LOS) environment, and a strength of a measured signal.

In an example embodiment, acquiring the measurement location information and the distance information may include acquiring a location of the electronic device and a distance between the electronic device and the target electronic device at each of the plurality of measurement locations.

In an example embodiment, acquiring the measurement location information and the distance information may include: acquiring a first location of the electronic device and a first distance between the electronic device and the target electronic device at a first measurement location; acquiring a second location of the electronic device and a second distance between the electronic device and the target electronic device at a second measurement location which is different from the first measurement location; and acquiring a third location of the electronic device and a third distance between the electronic device and the target electronic device at a third measurement location which is different from the first measurement location and the second measurement location, the measurement location information may include the first location, the second location, and the third location, and the distance information may include the first distance, the second distance, and the third distance.

In an example embodiment, the plurality of measurement locations may be at least a part of locations for acquiring location information of the electronic device.

In an example embodiment, acquiring the distance information may include acquiring the distance information using an ultra-wideband (UWB) module.

According to an example embodiment of the disclosure, an electronic device may include a communication circuit, a memory configured to store instructions, and at least one processor connected with the communication circuit and the memory and configured to execute the instructions, and, by executing the instructions, the at least one processor may acquire measurement location information which includes a plurality of measurement locations, and distance information which includes a plurality of distances between the plurality of measurement locations and a target electronic device, may acquire first location information of the target electronic device based on the measurement location information and the distance information, may identify an accuracy of the first location information based on the measurement location information, the distance information, and the first location information, and may determine a location of the target electronic device based on the accuracy of the first location information.

In an example embodiment, by executing the instructions, the at least one processor may, when the accuracy is less than or equal to a threshold value, acquire additional measurement location information which includes at least one additional measurement location, and additional distance information which includes at least one distance between the at least one additional measurement location and the target electronic device, may acquire second location information of the target electronic device based on the additional measurement location information and the additional distance information, may identify an accuracy of the second location information based on the additional measurement location information, the additional distance information, and the second location information, and may determine the location of the target electronic device based on the second location information.

In an example embodiment, by executing the instructions, the at least one processor may acquire preference measurement location information related to a measurement location where it is possible to improve the accuracy, and may output the preference measurement location information.

In an example embodiment, by executing the instructions, the at least one processor may, when the accuracy is greater than or equal to a threshold value, determine the location of the target electronic device based on the first location information.

In an example embodiment, by executing the instructions, the at least one processor may acquire a dilution of precision (DoP) value based on the distance information and the first location information, and may identify the accuracy of the first location information based on the DoP value.

In an example embodiment, by executing the instructions, the at least one processor may identify the accuracy of the first location information based on at least one of a distance between the electronic device and the target electronic device, whether the electronic device and the target electronic device are in a line of sight (LOS) environment, and a strength of a measured signal.

In an example embodiment, by executing the instructions, the at least one processor may acquire a location of the electronic device and a distance between the electronic device and the target electronic device at each of the plurality of measurement locations.

In an example embodiment, by executing the instructions, the at least one processor may acquire a first location of the electronic device and a first distance between the electronic device and the target electronic device at a first measurement location, may acquire a second location of the electronic device and a second distance between the electronic device and the target electronic device at a second measurement location which is different from the first measurement location, and may acquire a third location of the electronic device and a third distance between the electronic device and the target electronic device at a third measurement location which is different from the first measurement location and the second measurement location, the measurement location information may include the first location, the second location, and the third location, and the distance information may include the first distance, the second distance, and the third distance.

In an example embodiment, the plurality of measurement locations may be at least a part of locations for acquiring location information of the electronic device.

In an example embodiment, the communication circuit may include an ultra-wideband (UWB) module, and, by executing the instructions, the at least one processor may acquire the distance information using the UWB module.

While the disclosure has been illustrated and described with reference to various example embodiments, it will be understood that the various example embodiments are intended to be illustrative, not limiting. It will be further understood by those skilled in the art that various modifications, alternatives and/or variations of the various example embodiments may be made without departing from the true technical spirit and full technical scope of the disclosure, including the appended claims and their equivalents. It will also be understood that any of the embodiment(s) described herein may be used in conjunction with any other embodiment(s) described herein.

What is claimed is:

1. A method of operating an electronic device, the method comprising:
acquiring measurement location information including a plurality of measurement locations, and distance information including a plurality of distances between the plurality of measurement locations and a target electronic device;
acquiring first location information of the target electronic device based on the measurement location information and the distance information;
identifying an accuracy of the first location information based on the measurement location information, the distance information, and the first location information; and
determining a location of the target electronic device based on the accuracy of the first location information.

2. The method of claim 1, wherein determining the location of the target electronic device comprises:
based on the accuracy being less than a threshold value, acquiring additional measurement location information including at least one additional measurement location, and additional distance information including at least one distance between the at least one additional measurement location and the target electronic device;
acquiring second location information of the target electronic device based on the additional measurement location information and the additional distance information;
identifying an accuracy of the second location information based on the additional measurement location information, the additional distance information, and the second location information; and
determining the location of the target electronic device based on the second location information.

3. The method of claim 2, further comprising:
acquiring preference measurement location information related to a measurement location based on it being possible to improve the accuracy; and
outputting the preference measurement location information.

4. The method of claim 1, wherein determining the location of the target electronic device based on the accuracy of the first location information comprises, based on the accuracy being greater than or equal to a threshold value, determining the location of the target electronic device based on the first location information.

5. The method of claim 1, wherein identifying the accuracy of the first location information comprises:
acquiring a dilution of precision (DoP) value based on the distance information and the first location information; and
identifying the accuracy of the first location information based on the DoP value.

6. The method of claim 1, wherein identifying the accuracy of the first location information comprises identifying the accuracy of the first location information based on at least one of a distance between the electronic device and the target electronic device, whether the electronic device and the target electronic device are in a line of sight (LOS) environment, and a strength of a measured signal.

7. The method of claim 1, wherein acquiring the measurement location information and the distance information comprises acquiring a location of the electronic device and a distance between the electronic device and the target electronic device at each of the plurality of measurement locations.

8. The method of claim 7, wherein acquiring the measurement location information and the distance information comprises:
acquiring a first location of the electronic device and a first distance between the electronic device and the target electronic device at a first measurement location;
acquiring a second location of the electronic device and a second distance between the electronic device and the target electronic device at a second measurement location different from the first measurement location; and
acquiring a third location of the electronic device and a third distance between the electronic device and the target electronic device at a third measurement location different from the first measurement location and the second measurement location,
wherein the measurement location information comprises the first location, the second location, and the third location, and
wherein the distance information comprises the first distance, the second distance, and the third distance.

9. The method of claim 1, wherein the plurality of measurement locations are at least a part of locations for acquiring location information of the electronic device.

10. The method of claim 1, wherein acquiring the distance information comprises acquiring the distance information using an ultra-wideband (UWB) module.

11. An electronic device comprising:
a communication circuit;
a memory configured to store instructions; and
at least one processor, comprising processing circuitry, connected with the communication circuit and the memory, wherein at least one processor, individually and/or collectively, is configured to execute the instructions and to cause the electronic device to:
acquiring measurement location information including a plurality of measurement locations, and distance information including a plurality of distances between the plurality of measurement locations and a target electronic device;
acquire first location information of the target electronic device based on the measurement location information and the distance information;
identify an accuracy of the first location information based on the measurement location information, the distance information, and the first location information; and
determine a location of the target electronic device based on the accuracy of the first location information.

12. The electronic device of claim 11, wherein at least one processor, individually and/or collectively, is configured to cause the electronic device to:
based on the accuracy being less than or equal to a threshold value, acquire additional measurement location information including at least one additional measurement location, and additional distance information including at least one distance between the at least one additional measurement location and the target electronic device;
acquire second location information of the target electronic device based on the additional measurement location information and the additional distance information;
identify an accuracy of the second location information based on the additional measurement location information, the additional distance information, and the second location information; and
determine the location of the target electronic device based on the second location information.

13. The electronic device of claim 11, wherein at least one processor, individually and/or collectively, is configured to cause the electronic device to: based on the accuracy being greater than or equal to a threshold value, determine the location of the target electronic device based on the first location information.

14. The electronic device of claim 11, wherein at least one processor, individually and/or collectively, is configured to cause the electronic device to:
acquire a dilution of precision (DoP) value based on the distance information and the first location information; and
identify the accuracy of the first location information based on the DoP value.

15. The electronic device of claim 11, wherein at least one processor, individually and/or collectively, is configured to cause the electronic device to: identify the accuracy of the first location information based on at least one of a distance between the electronic device and the target electronic device, whether the electronic device and the target electronic device are in a line of sight (LOS) environment, and a strength of a measured signal.
